(19) United States
(12) Patent Application Publication
(10) Pub. No.: US 2017/0150706 A1
(43) Pub. Date: Jun. 1, 2017

(54) FISHING JIG

(71) Applicants: Inho Jung, Cape May Court House, NJ (US); Robin Sanghyun Jung, Cape May Court House, NJ (US)

(72) Inventors: Inho Jung, Cape May Court House, NJ (US); Robin Sanghyun Jung, Cape May Court House, NJ (US)

(21) Appl. No.: 14/954,262

(22) Filed: Nov. 30, 2015

(51) Int. Cl. A01K 85/16

(52) U.S. Cl. CPC A01K 85/16

(57) ABSTRACT

An improved jig, such as a bucktail jig, is disclosed. A leader assembly is configured to be able to slide within a conduit through the jig body but not be removed. The hook can be attached to the back of the leader assembly by a releasable coupler that has a release point less than a predetermined breaking strength of the leader assembly.

### FIELD OF THE INVENTION

This invention relates to an improved fishing jig.

### BACKGROUND

There are various types of fishing lures used in fishing as a replacement for, or in conjunction with, using bait. One type of fishing lure is a jig. Other types of lures include spinners, spoons, plugs, and flies.

A conventional jig is made of a weighted body with an embedded hook and is usually combined with a skirt of soft material, strings, fibers, or other cover to help attract fish. One type of conventional jig is known as a bucktail jig. This jig has a generally fish-shaped weighted body and a skirt made of dyed or natural deer tail hair. The leader is connected to an eyelet on the jig body.

Unlike fishing lures that are intended to move through the water horizontally, jigs are designed to sink. A jigger (a person who is fishing with a jig) will typically cast the jig out, wait until it sinks to the bottom, then control the fishing rod and line to move the reel the jig in with a jerking, bouncy motion, typically hopping the jig along near the bottom of the water.

An important aspect of jigging is being able to detect when a fish strikes the jig. A jigger detects the strike by feeling tugs and other vibrations from the fish strike transmitted through the jig and line to the fishing rod. Detecting the strike is perhaps the hardest aspect of jigging. However, the signals from a fish strike can be damped by the weight of the jig itself, making the strike more difficult to detect, particularly when a relatively heavy jig is used.

Because jigs are intended to be used at or near the bottom, they are also more likely to be caught on debris. If pulling on the line does not release the hook, the jigger typically has no option other than cutting the line (or pulling on it until it breaks), and losing the jig.

It would be beneficial to provide an improved jig, such as a bucktail jig, which provides a jigger with increased sensitivity to fish strikes. It would also be beneficial if such an improved jig could be retrieved even if the hook gets caught on underwater debris and cannot be unhooked.

### SUMMARY

These and other benefits are provided by a fishing jig comprised of a weighted body with a skirt, such as bucktail fibers, mounted to it. Instead of molding the hook into the weighted body, as in a conventional jig, the hook is attached to a leader assembly that passes through a conduit in the jig body. The conduit can run straight through the jig along its axis. Alternatively, the conduit can be tilted relative to the axis of the jig or curved so that the leader enters the jig at an angle. A coupler, such as a swivel coupler, is attached to the front of the leader. The back of the leader has another coupler, such as a solid ring. Other components, such as slidable beads can also be placed on the front and back portions of the leader. The components attached to the ends of the leader are too large to pass through the conduit and so the leader can slide freely within the conduit but cannot be removed. A hook is connected directly or indirectly to the second coupler and thereby to the leader.

In use, the hook and other components attached to the back of the leader will be pulled up to the back of the jig body and so be positioned in generally the same place as a hook that is embedded in the body of a conventional jig. However, when a fish strikes, the hook and leader assembly can slide freely relative to the jig body. As a result, the feel of the strike is transmitted through the line without damping by the weight of the jig body itself and thus can be more easily detected by the jigger.

The hook can be connected to the coupler at the back of the jig by a releasable coupler that has a release point at which it breaks or disconnects under tension that is less than the breaking strength of the leader assembly. As a result, if the hook gets snagged, the releasable coupler will disconnect before the leader breaks. While the hook may be lost, the other components remain connected to the back of the leader and prevent the rest of the jig assembly from being lost.

The configuration according to aspects of the invention also allows for hooks to be exchanged quickly and efficiently so that the same jig can be used when fishing for different types of fish that may require differently sized hooks.

### BRIEF DESCRIPTION OF THE FIGURES

Further features and advantages of the invention, as well as structure and operation of various implementations of the invention, are disclosed in detail below with references to the accompanying drawings:

FIG. 1 is a diagram of a fishing jig according to one embodiment of the invention;

FIG. 2 shows the jig of FIG. 1 with the jig body in cross-section and the skirt omitted;

FIG. 3 shows the jig of FIG. 1 with the leader assembly pulled all the way forward;

FIG. 4A shows an alternative embodiment of the invention; and

FIG. 4B shows the jig of FIG. 4A with the jig body in cross-section and the skirt omitted;

### DETAILED DESCRIPTION OF PREFERRED EMBODIMENTS

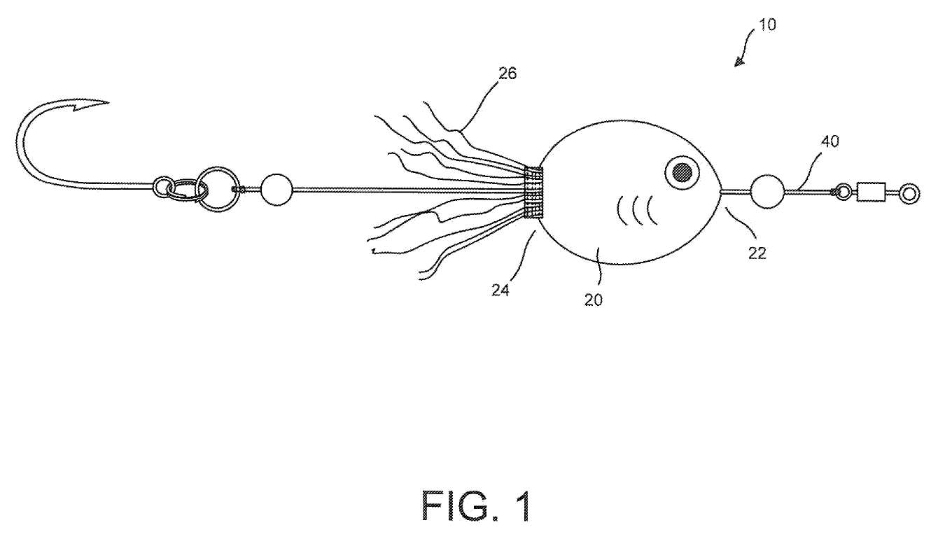

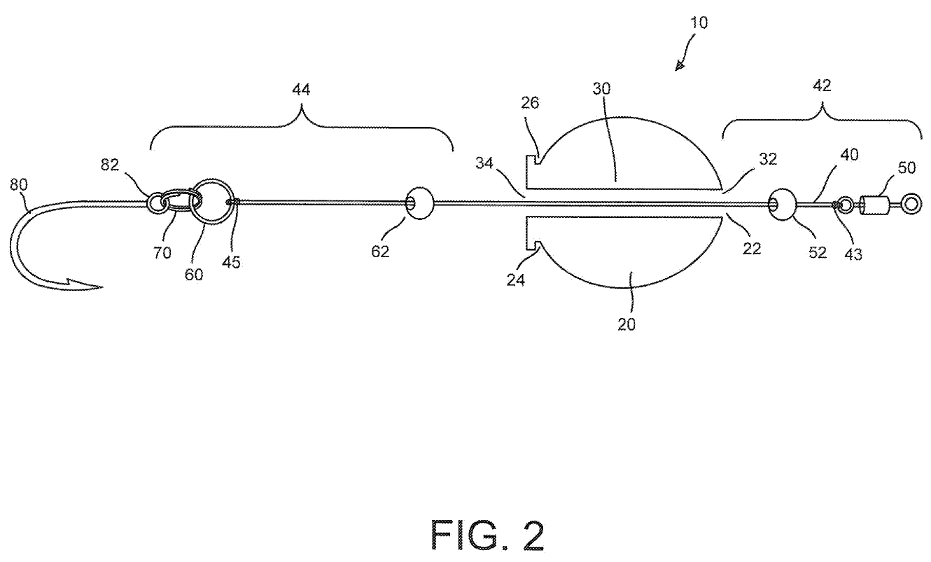

With reference to FIGS. 1 and 2, a fishing jig 10 is comprised of a weighted body 20 with a front 22 and a back 24. The weighted body can be made of lead or other metals and can be given a variety of shapes, such as bullet shaped, oval shaped, fish-shaped, etc. A skirt 26 is mounted to the body 24, such as by attaching it to a mounting portion 26 at the back. The skirt can be made of silicon, rubber, and other natural or manufactured sheet or fibrous materials. In a specific embodiment, the skirt is buck tail fibers. The skirt and weighted body can be colored and other designs or indicia can be formed thereon.

The weighted body has a weight sufficient for the jig to easily sink so that when fishing, the jigger can make the jig made along or near the bottom of the water. In typical embodiment, the weighted body can have a weight of less than one ounce to as heavy as three ounces or more.

As shown more clearly in FIG. 2, the body 20 has a conduit 30 passing through it. The conduit 30 has a front opening 32 at the front 22 of the body and a back opening 34 at the back 24 of the body. The conduit may also have a generally constant diameter throughout. A leader 40 passes through the conduit and can freely slide therein. A first portion 42 of the leader 40 extends out of the front of the weighted body and has a first end 43. A second portion 44 of the leader 40 extends out of the back of the weighted body and has a second end 45.

A first coupler 50, such as a swivel, is attached to the front end 43 of the leader 40. Other components, such as a slidable bead 52 can also be placed on the first portion 42 of the leader 40. A second coupler 60, such as a solid ring, is attached to the back end 45 of the leader 40. Other components, such as a slidable bead 62 can also be placed on the second portion 44 of the leader 40. One or more, of the components attached to each of the first and second portions 42, 44 of the leader 40 are too large to pass through the conduit. As a result, while the leader 40 is free to slide back and forth within the conduit 30, it is still held captive by the attached components and so cannot be removed from the body 20. The length of the leader should be sufficiently longer than the length of the conduit 30 so that it can slide at least somewhat within the conduit. In one embodiment, the length of the leader 40 is at least twice the length of the conduit 30.

In a particular embodiment, one or more of the components attached to the first portion 42 of the leader 40 are too large to pass through the front opening 32 of the conduit 30 and one or more of the components attached to the second portion 44 of the leader 40 are too large to pass through the back opening 34. In a more specific version of this embodiment, (i) a bead 52 larger than the front opening 32 of the conduit 30 is slideably mounted on the front portion 42 of the leader and a swivel coupler 50 larger than the hole through the bead 52 is attached to the front end 43 of the leader, and (ii) a bead 62 larger than the back opening 34 of the conduit 30 is slideably mounted on the back portion 44 of the leader and a solid ring coupler 60 larger than the hole through the bead 62 is attached to the back end 45 of the leader.

A releasable coupler 70 is attached to the second coupler 60. A hook 80 with an eye 82 can then be connected to the jig, preferably via the releasable coupler 70.

Advantageously, because the hook is not molded into the jig body, a jigger can quickly and efficiently change the specific hook used. This allows the same jig to be easily adapted for many different types of fish. For example, a fish such as a fluke would require a smaller hook while a fish like a grouper would require a larger, stronger one.

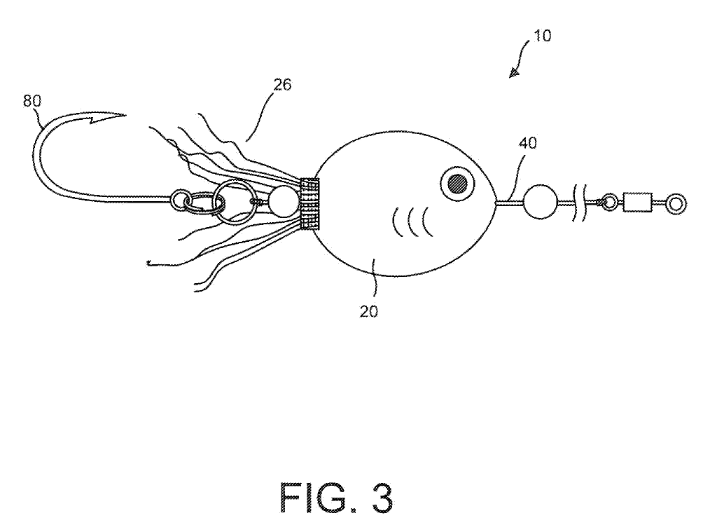

One important aspect of fishing with a jig is feeling when a fish strikes. When the jig 10 is used during fishing, the body 20 will typically slide to the back of the leader 40 so that the components on the second portion 44 of the leader 40 are bunched up near the end 45 of the leader. This configuration is shown in FIG. 3. When a fish strikes, the hook and leader assembly can slide relative to the jig body 20. As a result, the feel of the strike transmitted through the line to, the fisherman is improved relative to conventional jigs in which the hook is molded into the body of the jig and where the weight of the jig body damps signals of a fish strike.

The leader 40 has a predetermined breaking strength which reflects its tensile strength and the static tension weight it can take before breaking. A typical leader might be made of a 20-pound test material, such as wire, monofilament, braided, or fluorocarbon line. The breaking strength of the leader is likely to be reduced somewhat by the manner in which it is connected to the couplers 50, 60 because knots are often not as strong as the knotted material itself. Knot strength can be expressed in the percentage of the strength of the knotted line at which the knot will break. For example, a leader 40 made of 20-pound test material connected to the first and second couplers 50, 60 with a knot having a strength of 95% would be expected to break at 19 pounds of tension.

According to a further aspect of the invention, the releasable coupler is configured to have a release point at which it breaks or disconnects from the hook eye 82 or second coupler 60 that is less than the breaking strength of the leader. As a result, if the hook 80 gets snagged, the releasable coupler will disconnect before the leader 80 breaks. Because the remaining components at the back of the leader cannot pass through the conduit in the jig, even though the hook is lost, the jig assembly can still be retrieved. In contrast, in conventional jigs where the hook is molded into the body of the jig, the entire jig would be lost. Various releasable couplers can be used, configured to break, deform, etc, at the desired release point. In a particular embodiment, the releasable coupler 70 is a metal split ring with a ‘test’ that is less than the predetermined breaking strength of the leader 40 and where the split ring wire will deform and the ring open when under tension greater than the release point. In an example in which the leader 40 is made of 20-pound test material and connected to the couplers 50, 60 using 95% strength knots, the releasable coupler 70 can be a stainless steel split ring with a 15-18 pound test.

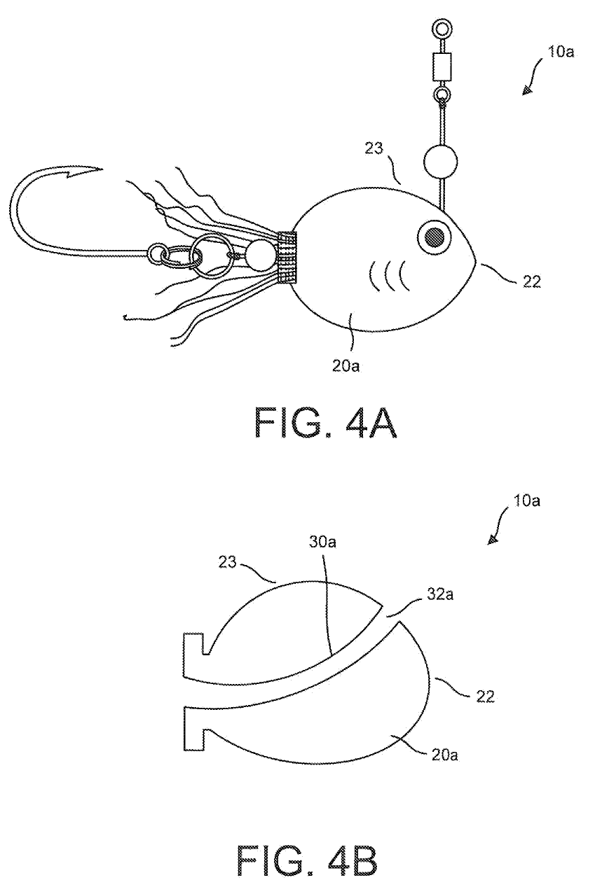

In the embodiment shown in FIGS. 1-3, the conduit 30 is straight and runs from the front 22 to the rear 24 of the body 20 generally along a central axis of the body. In an alternative embodiment the conduit is tilted upwards relative to the central axis of the body so that the entry point of the leader is a point between the front and the top of the jig body. For example, as shown in FIGS. 4A and 4B, a jig 10a is formed with a conduit 30a through the body 20a with an opening 32a that is above the front 22 of the body. The leader 40 thus enters the jig body 20a at an angle relative to its exit (from the back opening 34 of the conduit at the hack of the body 24). The angle can be chosen so that the jig will remains consistently parallel to the sea floor, (which is the optimal position for effective jigging). As shown in FIG. 4B, the conduit 30a can be curved, such as with a curve of between 45 and 90 degrees. Alternatively, a straight conduit that is simply angled upwards relative to front of the jig can be used. Other conduit shapes can be used as well, such as an angled or bent conduit instead of a curved conduit.

In yet a further embodiment, multiple conduits can be provided that join at a common back opening but have differently positioned front openings at different angles relative to the central axis of the jig. For example, a jig can be formed with a first conduit 30, with a front opening 32 and back opening 34 such as shown in FIG. 2 and second conduit 32a, such as shown in FIG. 4B, with a front opening 32a and the same back opening 34 as the first conduit. The jigger can thread the leader 40 through the desired conduit to allow selection of the jig angle in the water as desired. More than 2 conduits can be provided. For example, three conduits can be provided with angles of about 0, 45, and 90 degrees.

Various aspects of the invention have been disclosed and described herein. However, various modifications, additions and alterations may, be made by one skilled in the art without departing from the spirit and scope of the invention as defined in the appended claims.

What is claimed is:

1. A fishing jig comprising:
a weighted body having a front, a top, and a back and a central axis from the front to the back of the body;
a skirt mounted to the body;
a conduit passing through the body and having a first opening in the body at a point between the front and the top of the body and a second opening at the back of the body;
a leader passing through and freely slidable within the conduit, the leader having a first portion with a first end extending from the first opening and a second portion with a second end extending from the second opening;
at least one front element mounted to the first portion of the leader, the at least one front element comprising a first coupler connected to the first end of the leader;
at least one back element mounted to the second portion of the leader, the at least one back element comprising a second coupler connected to the second end of the leader;
at least one of said at least one front element and at least one of said at least one back element being too large to pass through the conduit, whereby the leader is held captive within the conduit; and
a hook connected to the second coupler.

2. The fishing jig of claim 1, wherein the conduit is straight.

3. The fishing jig of claim 2, wherein the conduit is angled upwards relative to the central axis.

4. The fishing jig of claim 1, wherein the conduit is curved upwards relative to the central axis.

5. The fishing jig of claim 4, wherein the conduit is curved at an angle of between 45 and 90 degrees.

6. The fishing jig of claim 1, further comprising a releasable coupler attached to the second coupler and wherein the hook is connected to the second coupler via the releasable coupler;
the leader having a predetermined breaking strength and the releasable coupler having a release point that is less than the breaking strength of the leader.

7. The fishing jig of claim 6, wherein the releasable coupler is a split ring which will open when under tension greater than the release point.

8. The fishing jig of claim 1, wherein the first coupler is a swivel coupler and the second coupler is a solid ring.

9. The fishing jig of claim 1, wherein the at leas one front element further comprises a first slidably mounted bead larger than the first opening and the at least one back element further comprises a second slidably mounted bead larger than the second opening.

10. The fishing jig of claim 1, wherein the skirt comprises buck tail fibers.

11. The fishing jig of claim 1, wherein the conduit has a generally constant diameter throughout.

12. The fishing jig of claim 1, wherein a length of the leader is at least twice a length of the conduit between the first and second opening.

13. A fishing jig comprising:
a generally fish-body shaped weighted body having a front, a top, and a back;
a fibrous skirt mounted to the body;
a conduit passing through the body and having a first opening at a point between the front of the body and the top of the body and a second opening at the back of tire body;
a leader passing through and freely slidable within the conduit, the leader having a first portion with a first end extending from the first opening and a second portion with a second end extending from the second opening;
a swivel coupler larger than the first opening and connected to the first end of the leader;
a solid ring coupler larger than the second opening and connected to the second end of the leader;
a split ring coupler attached to the solid ring coupler;
a hook attached to the split ring coupler;
the leader having a predetermined breaking strength and the split ring coupler having a release point that is less than the breaking strength of the leader.

14. The fishing jig of claim 13, further comprising at least one bead slidably mounted to the leader.

15. A fishing jig comprising:
a weighted body having a front, a top, and a back and a central axis from the front to the back of the body;
a skirt mounted to the body;
a first conduit passing through the body and having a first opening in the body at a point between the front and the top of the body and a second opening at the back of the body;
a second conduit passing through the body and first opening in the body at a point between the front and the top of the body different from the first opening of the first conduit, the second conduit sharing the second opening of the first conduit,
a leader passing through and freely slidable within one of the first conduit or the second conduit, the leader having a first portion with a first end extending from the first opening of the respective conduit and a second portion with a second end extending from the second opening;
at least one front element mounted to the first portion of the leader, the at least one front element comprising a first coupler connected to the first end of the leader;
at least one back element mounted to the second portion of the leader, the at least one back element comprising a second coupler connected to the second end of the leader;
at least one of said at least one front element and at least one of said at least one back element being too large to pass through the conduit, whereby the leader is held captive within the conduit; and
a hook connected to the second coupler.

16. The fishing jig of claim 15, wherein the first conduit is straight and the second conduit is curved.
